(19) United States
(12) Patent Application Publication
(10) Pub. No.: US 2015/0085500 A1
(43) Pub. Date: Mar. 26, 2015

(54) RECESSED MINI-CAN LIGHTING ASSEMBLY

(71) Applicant: Canarm Ltd., Brockville (CA)

(72) Inventors: James A. Cooper, Maitland (CA); Hon Man Kuan, Shatin, N.T. (CN)

(73) Assignee: CANARM LTD., Brockville (CA)

(21) Appl. No.: 14/484,631

(22) Filed: Sep. 12, 2014

Related U.S. Application Data
(60) Provisional application No. 61/881,162, filed on Sep. 23, 2013.

(51) Int. Cl. F21S 8/02; F21K 99/00; F21V 19/00; F21V 23/06; F21V 29/00

(52) U.S. Cl. CPC F21S 8/02; F21V 23/06; F21V 29/004; F21V 19/004; F21V 19/0045; F21K 9/90; F21Y 2101/02
USPC 362/365; 362/364; 29/876

(57) ABSTRACT

A recessed lighting assembly has an integrated junction box, a removable insert configured to be secured within the junction box/housing, and a connector for connecting the electrical components to electrical wires of the cable within the interior of the junction box/housing. The insert comprises a light emitter, such as one or more LEDs, electrical components for supplying current to the light emitter, and an exterior portion that is exposed when the assembly is mounted to the structure. The connector may include one or more quick connect members for conveniently connecting household wires to electrical leads of the insert. The assembly may be installed by initially mounting the junction box/housing to structure, forming an electrical connection between the household wires and the fixture wires, and securing the insert within the junction box/housing.

### CROSS REFERENCE TO RELATED APPLICATION

This application claims priority from U.S. Patent Application No. 61/881,162, filed on Sep. 23, 2013, the contents of which are incorporated herein by reference in their entirety.

### FIELD

The present invention relates to recessed lighting fixtures for installation within a ceiling or other surface in a structure.

### BACKGROUND

Recessed lighting fixtures are widely used in residential construction as well as commercial, industrial and other building structures. A recessed lighting fixture may hold a variety of light emitters such as an incandescent, compact fluorescent or, in a more recent trend, light emitting diode (“LED”) lighting element. A typical recessed lighting fixture comprises a housing or “can” (these terms are used interchangeably herein) which when installed is recessed within a surface such as drywall, panelling or other external sheathing. The housing encloses electrical elements and a light source such as a light bulb. In most cases, a decorative ring-shaped cover is secured to the housing to cover the gap between the wallboard or other surface and the edge of the housing, so as to provide an attractive finished appearance. Optionally, the light emitter may be covered with a clear or translucent lens so as to diffuse the light. In most cases, the housing portion of the fixture is wholly recessed within the surface and is not visible after installation.

Electrical fixtures normally include electrical leads that connect the electrical components of the fixture to the household wiring. For safety reasons, the fixture leads are normally connected to the household wiring outside the fixture housing, within an electrical junction box that is separately mounted to the structure. The junction box normally consists of an enclosure that receives a multi-phase household power cable consisting of bundled individual wires. The individual wires of the household cable are separated within the junction box and are individually connected within the junction box to corresponding electrical leads from the fixture. The junction box normally provides a measure of insulation from heat generated by the fixture. A junction box of this type is routinely installed for use with most electrical connections in a structure such as light fixtures, outlets, fans, etc.

Several types of conventional recessed lighting fixtures exist to meet various requirements. For example, for new construction the can normally comprises a relatively large housing, typically cylindrical, which houses an insert for a bulb or other light source. The housing fixture is typically sized to dissipate heat generated by the light source, which in the case of a conventional incandescent bulb can be considerable. A new construction can is typically installed by bracing the housing to one or more ceiling beams or other structural elements. Electrical wires enter the housing from the junction box, which is separately installed to the structure adjacent to the housing.

The can may be uninsulated or insulated, depending on location of the fixture installation, building code requirements and other factors.

Another type of prior art fixture is intended for installation in pre-existing structures, for example for installation in a renovation. This type of fixture may be smaller and may be mounted directly to drywall or other sheathing, rather than to underlying structural elements. Normally, such fixtures still require the use of a separate junction box.

The separate installations of a junction box and a conventional recessed lighting housing is typically time consuming and can add significantly to the overall cost of a new construction. Both of these steps usually must be performed by a licensed electrician, which can be costly and can result in construction delays, scheduling issues and other drawbacks. Furthermore, the existence of multiple types of cans for different applications is a drawback in that this increases inventory costs for suppliers and installers and also makes it more difficult for homeowners and other non-professional electricians to install a lighting fixture.

Low wattage LEDs can be used as a light source without generating significant amounts of heat that requires dissipation. This has opened up the possibility of redesigning lighting fixtures to take advantage of the relatively low heat discharge of modern light emitters of this type. There is a need for improved recessed lighting fixtures that take advantage of the reduced heat loads generated by LED and other low-energy light emitters and which provide simplified lighting solutions.

### SUMMARY

The present invention is based in part on the unexpected discovery by the inventors that a lighting fixture having the elements described herein may integrate the functions of a junction box and a lighting fixture housing. Furthermore, when the assembly is adapted for use with a low-energy emitter such as an LED light source, the housing may be mounted directly to wallboard or other sheathing material, thereby dispensing with the need for mounting the assembly to an underlying beam or stud. Such an assembly may be quickly and easily installed, in some cases without requiring the skills of a licensed electrician.

According to one aspect, the invention relates to a recessed lighting assembly for mounting to a structure, such as a wall or ceiling of a house, building, etc. In this aspect, the assembly includes an integrated junction box and housing having a fastener to secure the housing to the structure and an inlet to admit a multi-phase electrical cable into the housing. The electrical cable typically comprises “source” wiring that is directly connected to an electrical panel or other major distribution point. Electrical connections between the source wiring and the fixture leads may occur within the integrated junction box/housing of the lighting assembly. According to this aspect, the assembly comprises:
an integrated junction box/housing configured to be mounted to the structure and configured to admit a multi-phase electrical cable into the interior of the junction box/housing;
a removable insert configured to be secured within the junction box/housing, the insert comprising a light emitter, such as one more LEDs, or a mount for a light emitter, electrical components for supplying current to the light emitter and an exterior portion which is exposed when the assembly is mounted to the structure; and
a connector for connecting the electrical components to electrical wires of the cable within the interior of the junction box/housing.

The insert may include a heat sink configured to absorb and dissipate heat generated by the electric circuit and/or the light emitter. The heat sink may form an exterior portion of the insert which is outside the junction/housing.

The connector may consist of one or more quick connect members which are configured to connect the electrical wires to the insert. According to one aspect, the quick connect member has a first component for electrical connection to an exposed end of the wire and a second component electrically connected to the electrical components of the insert wherein the first and second components form an electrical and a mechanical connection therebetween to transmit current from the electrical wires to the electrical components of the insert. The second component of the quick connect member may be mounted to the insert. According to a further aspect, the quick connect member may comprise an integral member wherein the first component comprises a socket within the quick connect member for receiving and engaging an exposed wire core of the household wires. The second component may comprise an additional socket within the member for receiving electrical leads from the insert. Alternatively, the first and second components may be separable from each other, such that the quick connect member comprises a receptacle for receiving a first of the wires and the first and second components comprises engagement members for fastening the components together for forming an electrical and mechanical connection therebetween. A support member may be mounted to the insert wherein at least the first of the components of the quick connect members are mounted to the support member.

The assembly may further include one or more fasteners for mounting the junction box/housing to the structure, for example to wallboard or other sheathing member of the structure. The fastener may comprise at least one set of opposing clamp members configured to clamp the sheathing member between the clamp members. A first of the clamp members may comprise a spring clip extending from the housing biased to move outwardly from the housing and a second of the clamp members may comprise a non-moveable protrusion of the housing, wherein the spring clip is configured to bear against an inside surface of the sheathing and the protrusion is configured to bear against an opposed outer surface of the sheathing.

According to a further aspect, the insert and the junction box/housing comprise interlocking members to fasten the insert to the junction box/housing. The interlocking members may comprise at least one protrusion extending from the junction box/housing or the insert and a slot within the other of the junction box/housing or insert wherein the slot is configured to receive the protrusion and is further configured as a cam to tighten the insert into the junction box/housing when the insert is rotated relative to the junction box/housing.

The junction box/housing may be configured for installation either during construction of the structure or retrofit into an existing structure.

According to a further aspect, the junction box/housing may comprise an uninsulated can that is configured for mounting directly to wallboard or other sheathing without being separately mounted to underlying structural members of the structure. A housing of this type is conventionally referred to as a “mini-can” due to its small size relative to a can intended to be directly secured to structural members of a structure.

According to another aspect, the invention relates to a method of installing a light fixture to a structure, wherein the fixture comprises an integrated junction box/housing and an insert comprising a light emitter or mount for a light emitter, electrical components for supplying current to the light emitter, a connection for connecting the electrical components to electrical wires within the junction box/housing and an exterior portion which is exposed when the assembly is mounted to the surface. The method comprises the steps of:
feeding a multiphase electrical cable into the interior of the junction box/housing,
mounting the junction box/housing to the structure,
forming an electrical connection between wires of the electrical cable and the insert and
securing the insert within the junction box/housing.

The physical components associated with the present method may comprise the assembly described herein.

Directional references used in this description are purely for convenience of description and generally refer to the assembly in a conventional ceiling mount. However, it will be understood that the invention may be oriented in any direction. Furthermore, any specific dimensions, construction materials and the like are provided herein merely by way of example and are not intended to limit the scope of the invention.

### BRIEF DESCRIPTION OF THE DRAWINGS

FIG. 1 is a side view, in perspective, of a recessed lighting fixture assembly according to the present invention.

FIG. 2 is a plan view from below of the assembly.

FIG. 3 is a plan view from below of the assembly showing the translucent lens removed.

FIG. 4 is a perspective view, from below, showing the housing portion of the assembly.

FIG. 5 is a plan view from below of the housing.

FIG. 6 is a perspective view from above of the housing.

FIG. 7 is an enlarged view showing the interior of the housing.

FIG. 8 is a plan view from above of the assembly.

FIG. 9 is a plan view from above, of the insert and cover plate.

FIG. 10 is an enlarged view of the insert portion of the assembly.

FIG. 11 is a side view in perspective, of the insert and cover plate of the assembly.

FIG. 12 is a plan view from above of the insert and cover plate.

FIG. 13 is an enlarged view of the electrical connection portions of the insert.

FIG. 14 is a schematic cutaway view of the present invention installed in a structure.

FIG. 15 is a further schematic cutaway view of the installed assembly, in exploded view.

FIG. 16 is a perspective view of a second embodiment of the invention, showing the insert portion.

FIG. 17 is a perspective view of the second embodiment, showing the exterior housing or “can” portion thereof.

### DETAILED DESCRIPTION

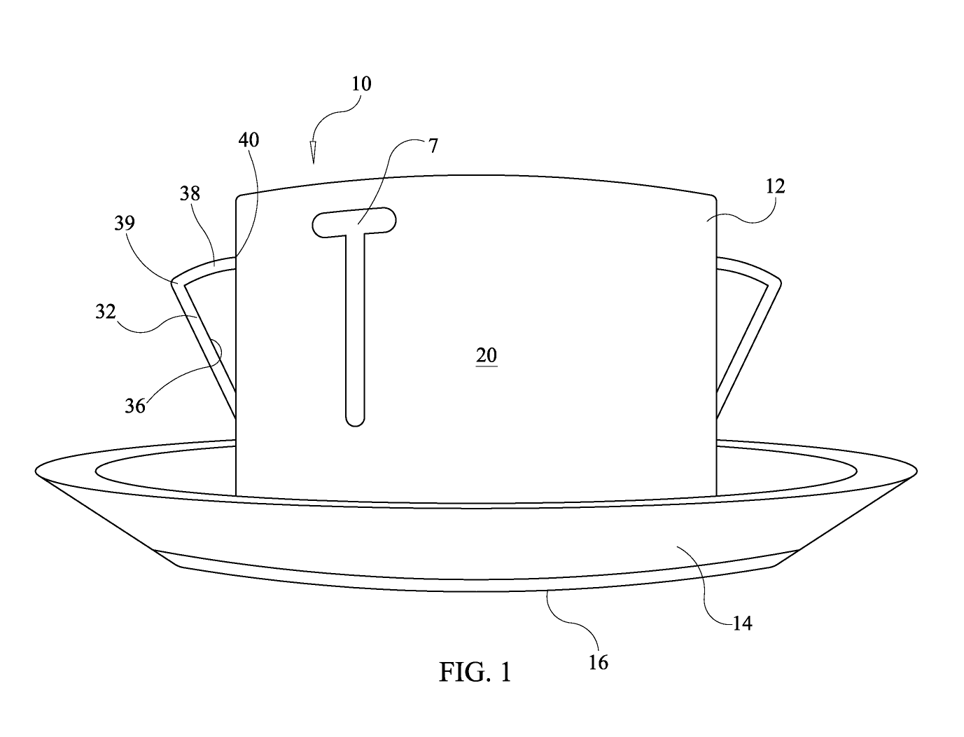

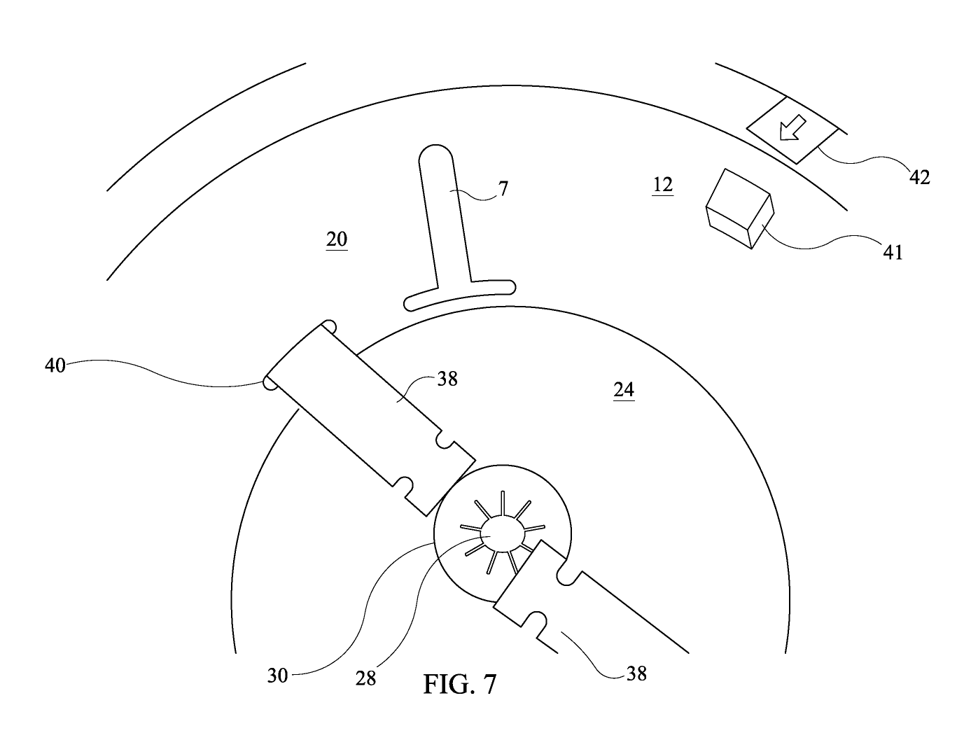

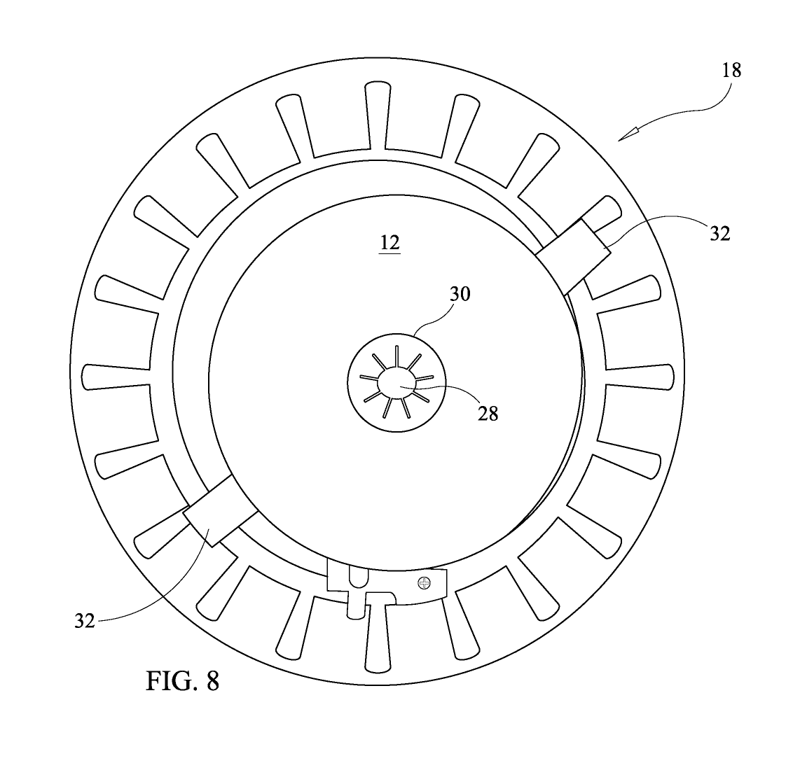

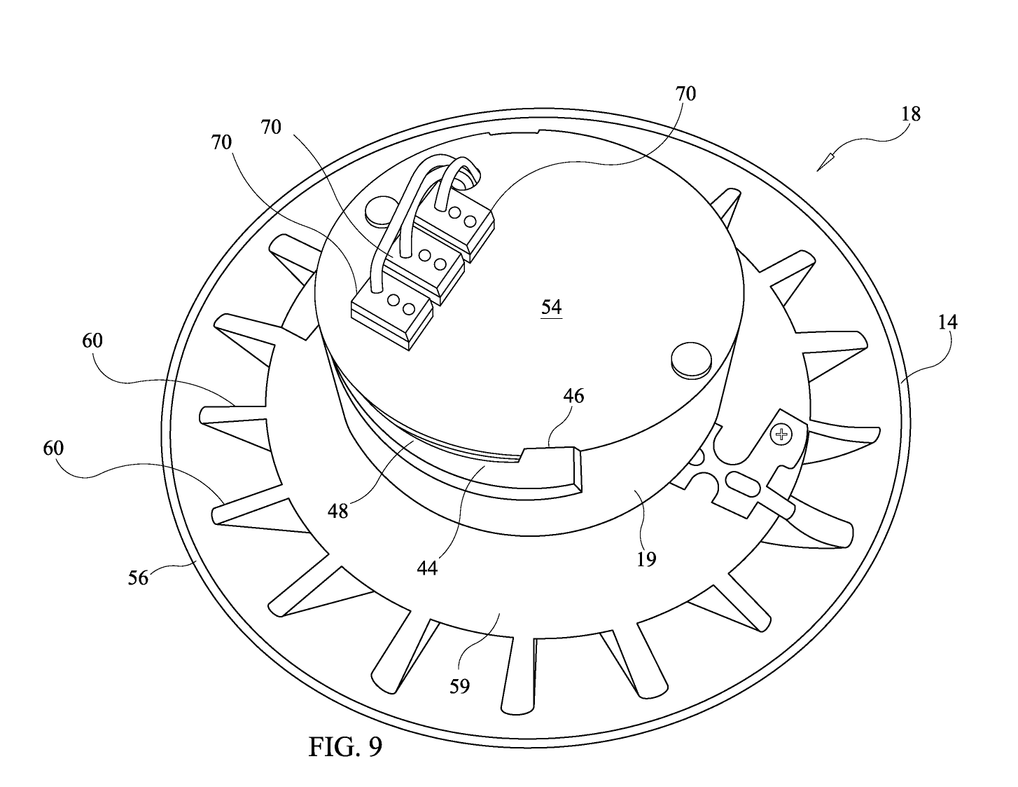

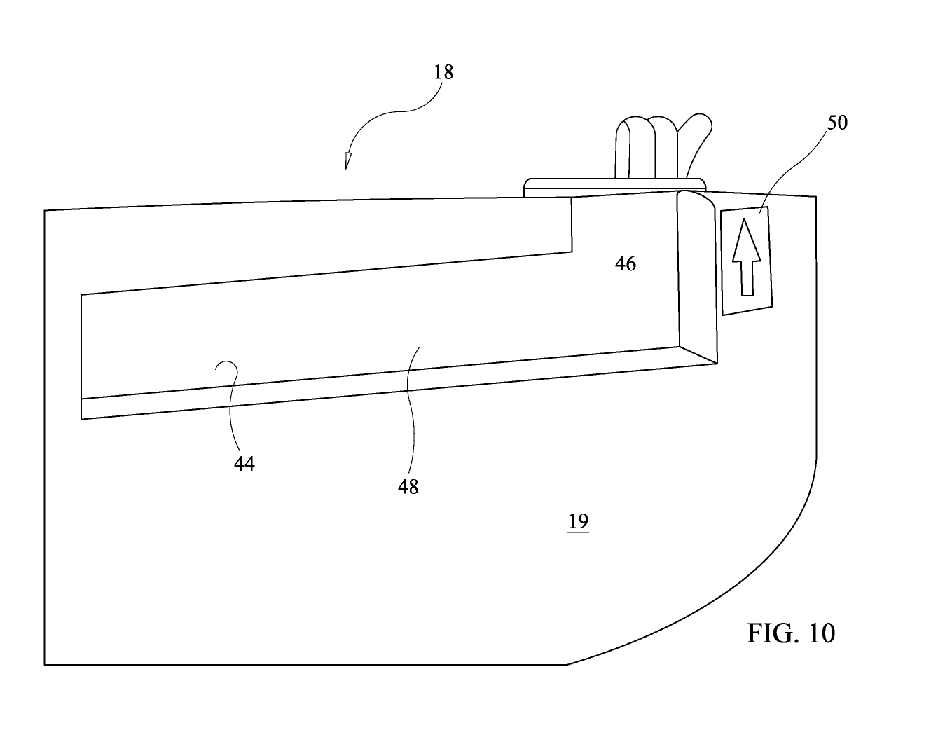

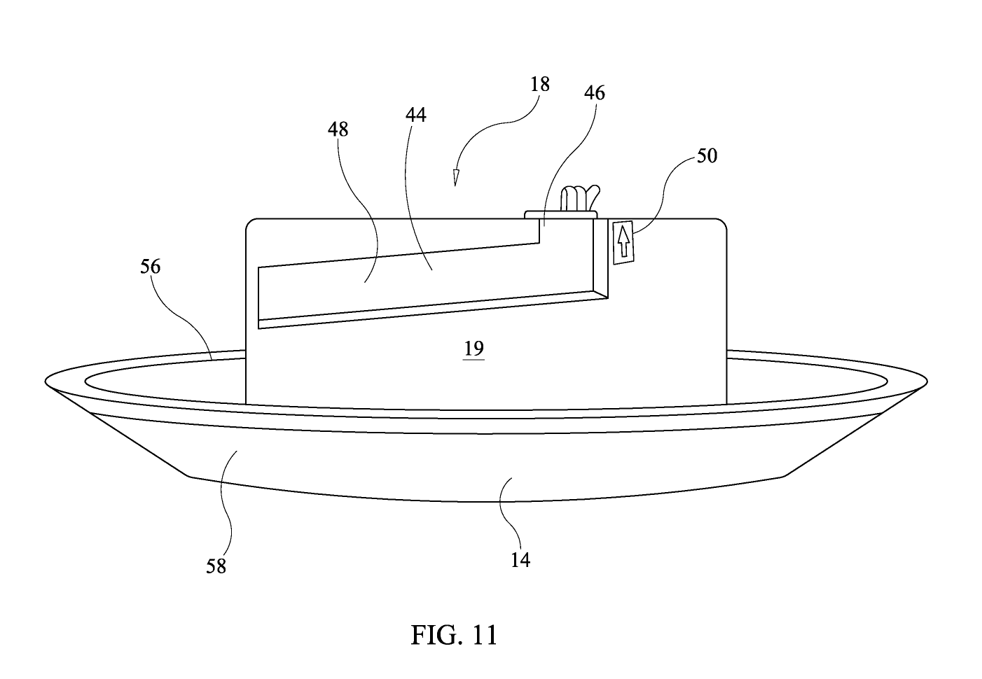

FIGS. 1-15 illustrate a first embodiment of a recessed lighting assembly according to the present invention. The assembly comprises a fixture 10 and associated components, described in detail below. Assembly 10, seen assembled in FIG. 1, comprises in general terms a housing 12, an annular-shaped cover plate 14, a transparent or translucent lens or dome 16 and an insert 18, which is seen in detail in FIGS. 9-13.

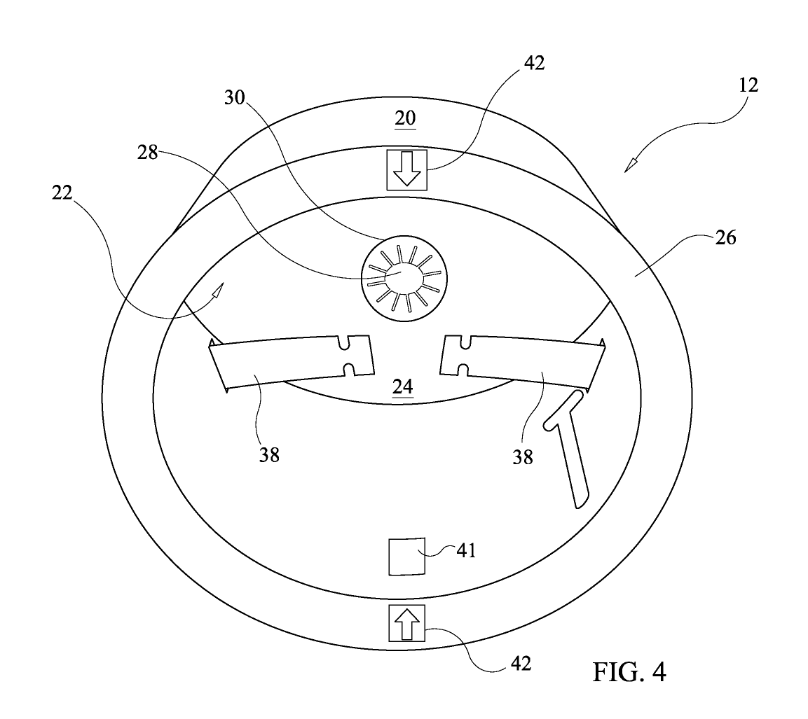

Housing 12, which may also be referred to as a “can”, is seen in particular detail in FIGS. 4-6. Housing 12 integrates the functions of a housing for electrical components (described below) and other elements of the light fixture, and an electrical junction box for receiving a multiphase electrical cable therein from the household wiring and connecting these wires with electrical leads of the lighting fixture within the housing interior. These two functions normally require separate housings in prior art systems but in the present invention they are combined within a single, integral junction box/housing 12.

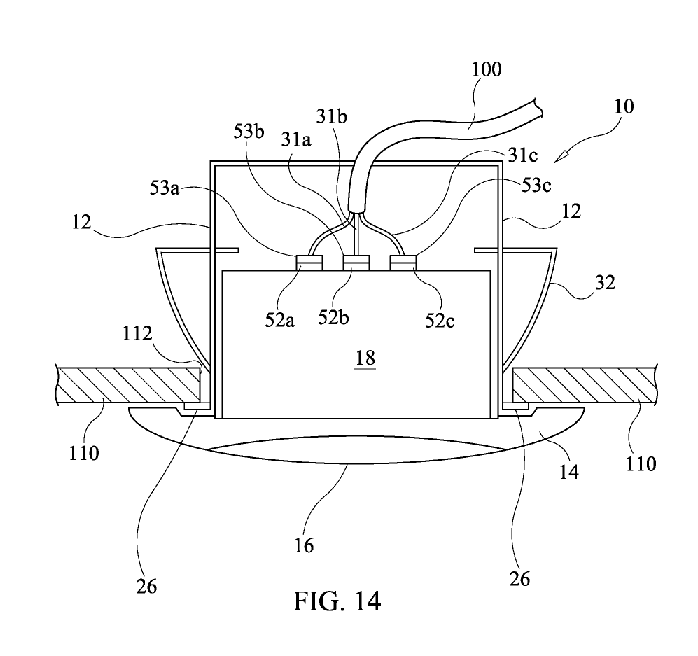

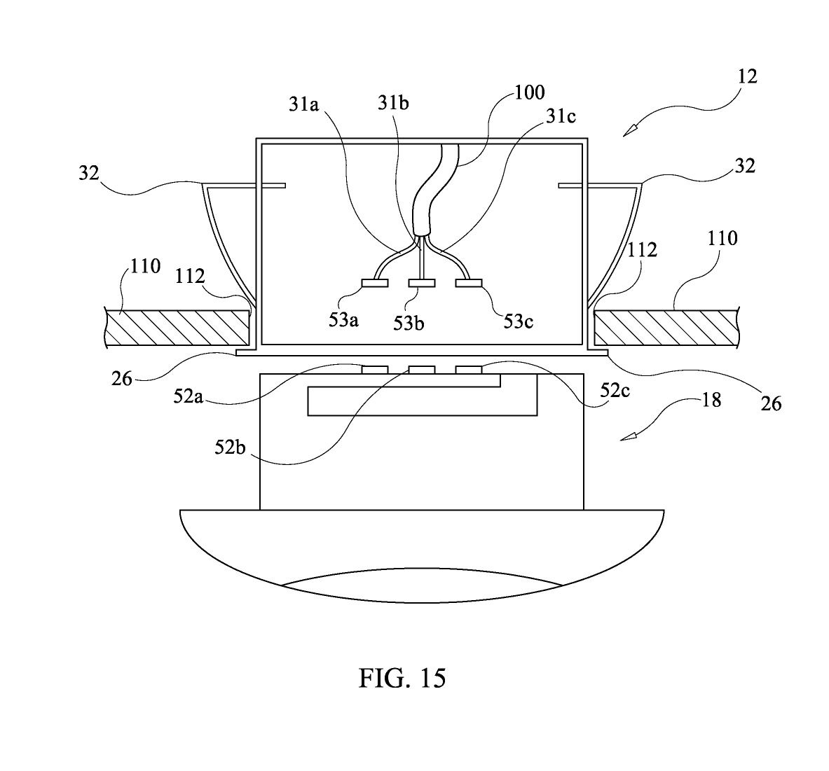

Housing 12 comprises a cylindrical sidewall 20 which defines an interior space and a downwardly-facing open end 22. The opposed end of housing 12 is closed with cover plate 24 and faces upwardly when installed in a ceiling mount. Housing 12 may be fabricated from metal or other rigid material that is suitable for use as a permanently-installed electrical fixture. Housing 12 further comprises an annular flange 26 that protrudes outwardly from sidewall 20 adjacent to first end 22. Cover plate 24 comprises an opening 28, partially covered with a flexible insert 30 which secures a conventional three phase household electrical cable 100 (seen in FIGS. 14 and 15) which enters housing 12 through opening 28. Ventilation slots 7 are provided through sidewalls 20 on opposing sides thereof to provide cooling.

Housing 12 may be installed in a structure in a new construction or a retrofit/renovation of an existing structure. Housing 12 may also be installed in applications that may conventionally require either one of an insulated or uninsulated can, in particular when used with a lower power LED light emitter as described herein which generates substantially less heat during use than a conventional incandescent light bulb. It will be further seen that housing 12 may be installed in any suitable surface such as a ceiling, wall, or other surface suitable for installation of a recessed lighting fixture.

As described below, housing 12 can be securely fastened to sheathing no of a wall, ceiling or other surface of a structure by a suitable fastening means. In the present embodiment, housing 12 is not required to be installed to an underlying structural element such as a stud or beam, but can be sufficiently secured by engagement with the wallboard or other sheathing material that forms an exposed surface of the structure, using grippers 32 that are resiliently biased to secure the housing within an opening in wall board or other sheathing. Grippers 32 serve to grip the sheathing by clamping the sheathing between flange 26 and a pair of opposed spring-biased sheathing grips 32 that protrude outwardly from wall 20 of housing 12.

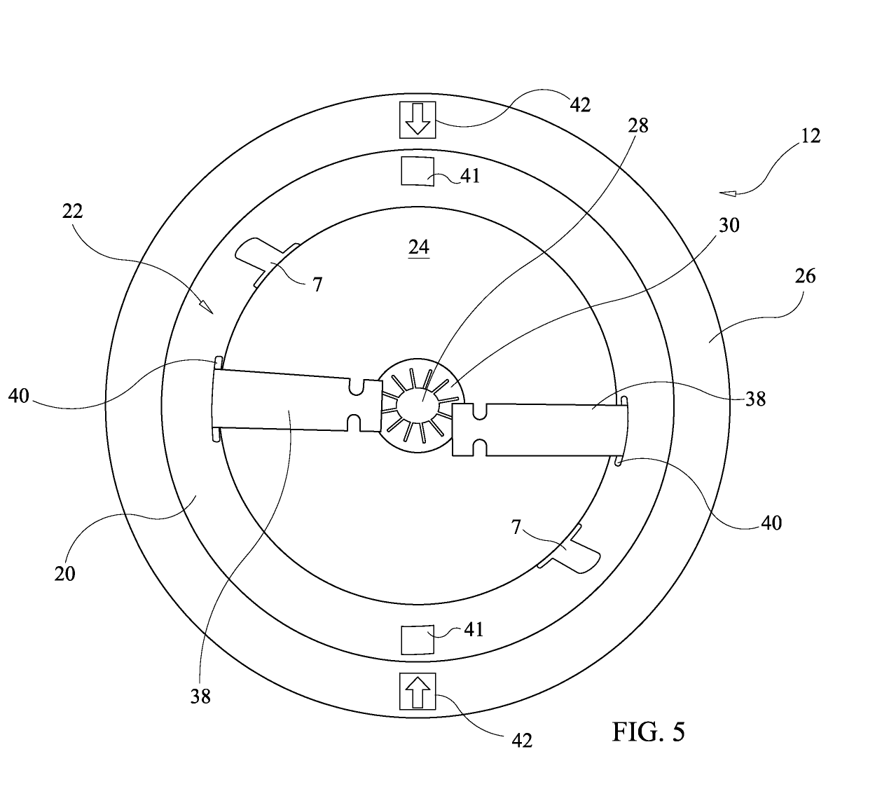

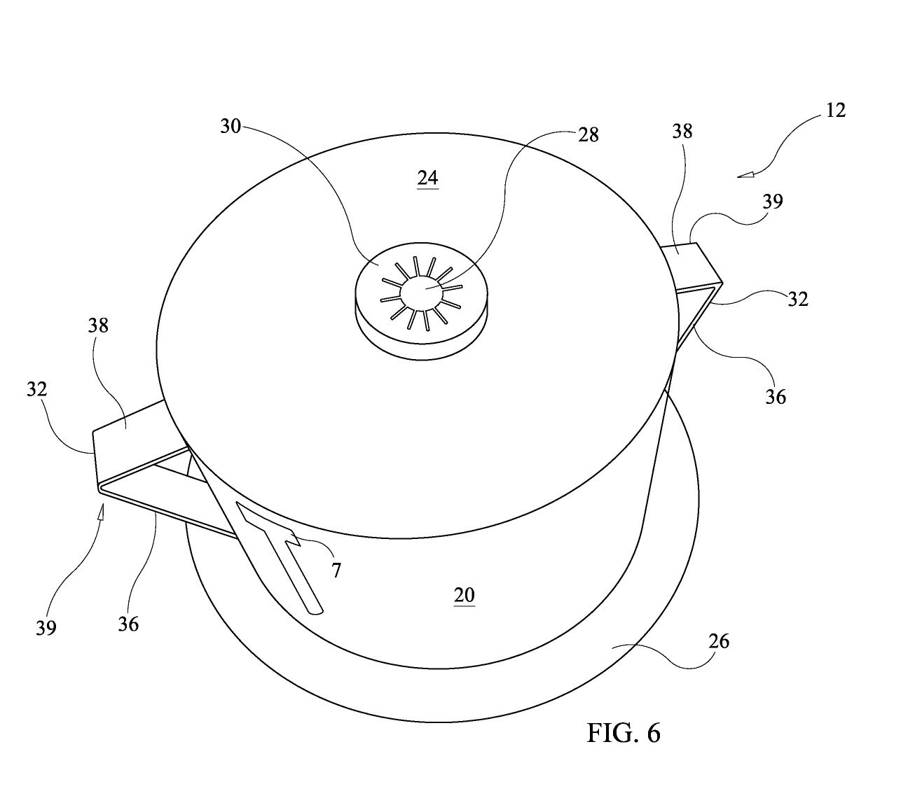

Sheathing grippers 32, seen in detail in FIG. 6, each comprise a flexible, resilient member that is spring-biased for radial expansion whereby grippers can be urged from an outwardly extended position as seen in FIG. 1, towards a compressed position as seen in FIG. 14 wherein grippers 32 are essentially flush against sidewall 20 and only minimally protrude therefrom. Grippers 32 are fabricated from spring steel or other resilient material and each comprise an essentially L-shaped member spring-biased for radially outward expansion towards the outwardly extended position. Each gripper 32 comprises a first, upper end fastened to housing 12 adjacent to flange 26. A first leg 36 of gripper 32 extends from the attached end generally parallel to sidewall 20 when compressed. A second leg 38 of gripper 32 extends inwardly from the lower end of leg 36 towards housing 12 and extends through an opening 40 within sidewall 20 to protrude into the interior of housing 12 (see FIGS. 4 and 5). Legs 36 and 38 meet at a shoulder 39.

Electric current is delivered to fixture 10 via a conventional three phase electrical cable 100 which delivers household current to assembly 10 (see FIGS. 14 and 15). Cable 100 comprises three individual coated wires 31a, b and c, consisting of negative, positive and ground wires bundled together in an exterior sheathing. Each of wires 31a-c comprises a conductive wire core surrounded by an insulating coating. Cable 100 may originate from the structure's electrical panel and is fed directly into the interior of housing 12 through opening 28. As described below, cable 100 may be separated into its constituent wires 31a-c within the interior of housing 12, and these in turn are electrically connected to leads of the lighting assembly within housing 12. Unlike with conventional electrical fixtures, it is not necessary to install a separate junction box to house these connections.

After cable 100 has been inserted into housing 12, housing 12 may be installed within a surface of the structure, as seen in FIGS. 14 and 15. A circular opening 112 is provided with the wallboard or other external sheathing of the structure for installation of housing 12, such that housing 12 fits within the opening and is installed therein. In order to fasten housing 12 to the wallboard, grippers 32 may be initially squeezed together such that legs 36 are substantially flush with sidewall 20. In this position, housing 12 can be inserted into opening 112 within the sheathing no, in which the opening 112 has been made slightly larger than the outside diameter of sidewall 20. Once housing 12 is partially inserted, grippers 32 may be released to spring outwardly so as to bear against the exposed edge of the sheathing opening 112. Alternatively, grippers 32 are urged together as housing 12 is inserted into sheathing opening by contact with the edges of the sheathing opening. As housing 12 is further inserted into the opening, grippers 32 can open further until the point of maximum insertion of housing 12 within the opening when flange 26 abuts the outside (exposed) surface of the sheathing. At this point, housing 12 is firmly secured to the sheathing by the clamping force provided between flange 26 and grippers 32. Grippers 32 bear against the edge of the opening and are angled at the point of contact therewith. This angled point of contact and outward biasing of grippers 32 exerts a longitudinal force on grippers 32 which urges the housing inwardly and generates a clamping force between flange 26 and grippers 32 respectively.

If it is necessary to remove fixture 10, this may accomplished by drawing together arms 38 from within the interior of housing 20 to release housing 12 and allow it to be removed for maintenance, replacement, etc.

Housing 12 is configured and fabricated to comply with normal regulatory requirements for an electrical junction box, whereby housing 12 may itself provide the function of a junction box as well as serving as the housing for a light emitter. As such, a free end of multiphase electrical cable 100 may be directly fed into the interior of housing 12 without the need for a separate junction box interposed between main cable 100 and leads from the electrical elements of assembly 10.

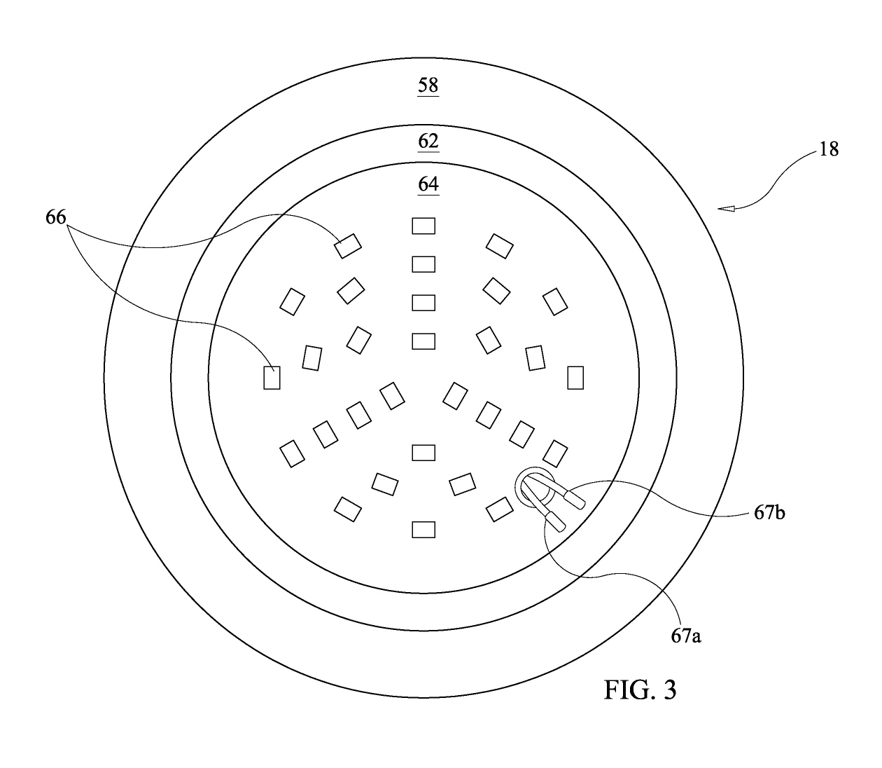

FIGS. 3 and 9-13 illustrate LED insert 18. Insert 18 comprises an essentially cylindrical body 19 configured to fit within the interior of housing 12 and interlock therewith. Body 19 comprises a rigid structure which may be fabricated from cast aluminum, moulded plastic or other suitable material. Body 19 releasably locks into housing 12 by means of cooperating members on the housing and body respectively that interlock with each other. The cooperating members include at least one and preferably two protrusions 41 located on opposing sides of housing 12 which protrude into the interior thereof from the inside surface of sidewall 20, as seen in FIGS. 4, 5 and 7. The location of protrusions 41 may be visually indicated to a user by arrows 42 or other visual indicators located on flange 26 or other exposed surface of housing 12. For mating and interlocking with protrusions 41, body 19 is provided with at least one and preferably multiple dogleg-shaped grooves 44 recessed into opposing sidewalls thereof. Grooves 44 are each L-shaped and comprise a cam portion 48 that extends substantially circumferentially around body 19 and an axially-extending entry portion 46 that communicates with cam portion 48. The respective entry portions 46 may be aligned with protrusions 41 to allow insert 18 to be inserted within housing 12 such that protrusions 41 are engaged within grooves 44. Cam portion 48 is slightly angled in axial direction, whereby when protrusions 41 are positioned within cam portions 48, rotation of body 19 generates a camming action with respect to protrusions 41 to tighten insert 18 against housing 12. When fully rotated, body 19 is effectively locked within housing 12, until it is released by counter-rotation. Body 19 may be provided with alignment indicators 50 for alignment with indicators 42 to permit the user to easily align protrusions 41 with entryway portion 46.

It will be seen that the relative positions of protrusions 40 of housing 12 and grooves 44 within insert 18 may be reversed.

When installed within housing 12, body 19 fills a top portion of the interior space of housing 12. An unfilled space between body 19 and cover plate 24 accommodates elements such as cable 100, wires 31a-c and quick connect members 52a-c and 53a-c, as described below.

The interior of body 19 comprises electronic elements, not shown, for supplying current to LED light emitters. The electronic components may comprise any such components known to the art for supplying current to a selected light emitter, including associated mechanical components, and may comprise an electrical/electronic circuit and other elements.

Body 19 comprises a substantially flat upper surface 54 which faces into the interior of housing 12 when installed thereto. As seen in FIGS. 14 and 15, three quick connect members 52a, b and c may be mounted within openings (not shown) within surface 54 to lower the exposed profile of these members. Quick connect members 52a-c are exposed to surface 54 and are electronically connected to the electrical/electronic components within body 19. Each of members 52a-c form half of a mating pair of quick connect members, which are configured to mechanically engage opposing quick connect members 53a, b and c. The opposing members 53a-c in turn can be independently connected to corresponding electrical wires 31a, b and c. The quick connects thus each comprise two members that can releasably engage each other, for example by a snap-lock connection, to form a mechanical and electrical connection between the mating halves. The respective halves 52 and 53 are normally engaged by urging them together manually—no tools are normally required to connect or disconnect the respective halves. As a result, forming an electrical connection between quick connect members 52 and 53 is a speedy operation that can be performed without possessing any special skills, and which reliably forms a secure electrical connection. Quick connect members 52a-c and 53a-c may comprise any of the types described in PCT application No. WO 2012/097453, the contents of which are incorporated by reference in its entirety.

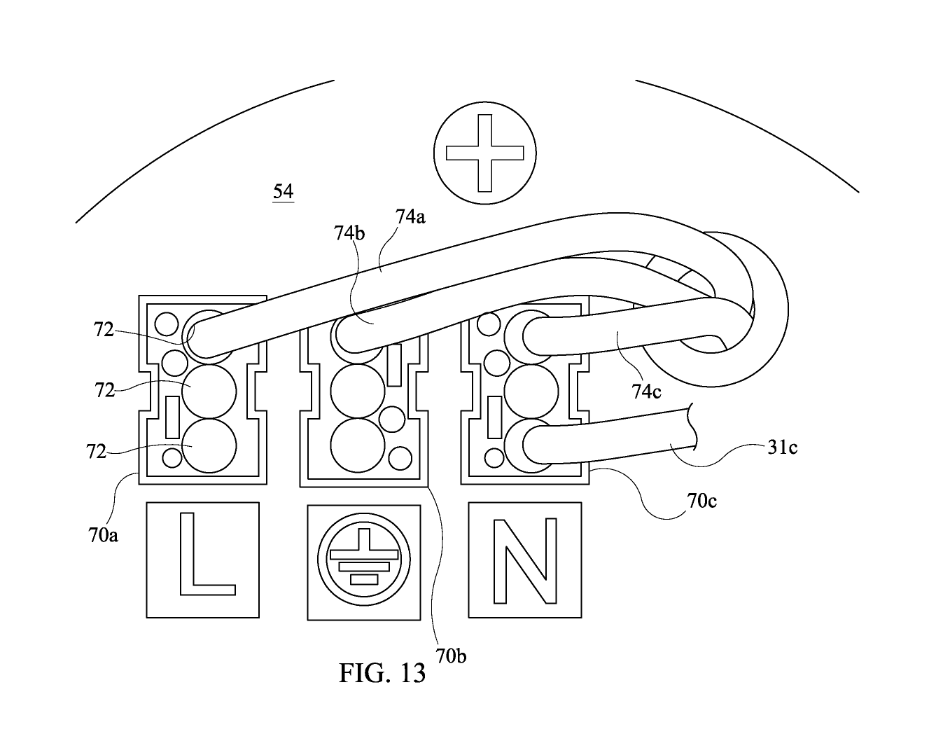

Alternatively, as seen in FIGS. 9 and 13, insert 18 may provide quick connect members 70a-c which comprise Canarm Easy Connect™ members or similar connectors. Quick connect members 70a-c each comprise an integral, one-piece member which is mounted to upper surface 54 of body 19. Each connector 70 comprises multiple push-in sockets 72, which are electrically connected together within the interior of member 70. The respective sockets 72 on each quick connect member 70 are configured to receive an exposed core of an electrical wire and securely grip this segment to prevent inadvertent release once inserted. The sockets include a conductive element within their interiors, not shown, to make an electrical connection with the wire cores. In order to form a secure electrical connection with a wire, an exposed segment of the wire core is inserted into a corresponding socket 72, which securely grips the wire and electrically connects it with other wires that have been inserted into other sockets within the same quick connect member 70. As is seen in FIG. 13, leads 74a, b and c from insert 18 are inserted into sockets 72 of corresponding ones of quick connect members 70a-c. Exposed cores of household wires 31a-c (only one of which is shown in FIG. 13 for clarity) may then be inserted in open sockets 72 within corresponding ones of members 70a-c. In this manner, household wires 31 are electrically connected to corresponding ones of fixture leads 74a-c. It will be seen that these electrical connections may be formed by simply inserting wires 31a-c into corresponding sockets 72 of quick connects 70a-c respectively.

In order to ensure that the respective quick connects are installed properly, they are all color coded to match the standard wire color coding of a three phase wire, for example white, green and black.

Connection of insert 18 to household wiring thus comprises the initial step of feeding cable 100 through opening 28 of housing 12. Normally, this step is performed prior to installation of housing 12 within the sheathing. The exposed end of cable 100 is then separated into wires 31a-c and these individual wires are then connected to corresponding quick connect members 53a-c or 70a-c. This step normally requires inserting exposed cores of wires 31a-c into corresponding sockets within the respective quick connects 53a-c or 70a-c, which electrically and mechanically connects the wires with corresponding quick connect members. In the case of quick connects 52/53, this step is followed by connecting quick connects 53a-c with corresponding quick connect members 52a-c on insert 18. For this purpose, the quick connect members are appropriately labelled and wires 31a-c are colour-coded for connection with the corresponding household wires. After the above electrical connections have been formed, insert 18 may be secured within housing 12. Alternatively, in case of quick connects 70a-c, no further connection steps are required after inserting wires 31 into corresponding sockets 72.

As seen in FIG. 3, body 19 includes flat recessed central surface 62 which supports an LED board 64. LED board 64 comprises an array of individual LED elements 66. The LED array may comprise any suitable number, type and configuration of LED elements 66 or, depending on lighting requirements, a single LED element 66. LED elements 66 are electrically connected to the electrical circuit within body 19 via leads 67a and b, which lead from the electrical circuit within body 19 for connection via quick connects 53 or 70.

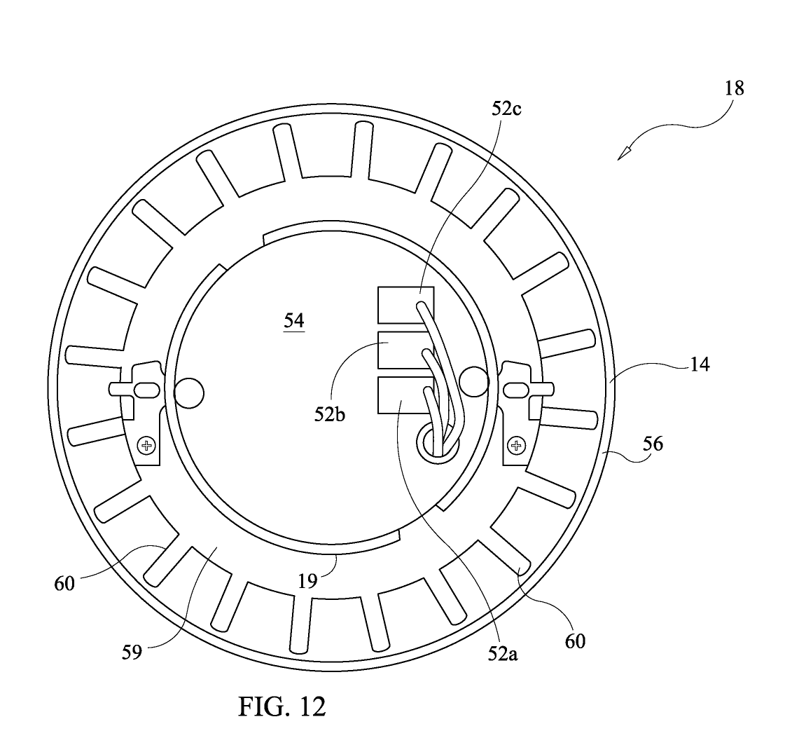

Cover plate 14 is mounted to or is integral with body 19 and comprises, in this embodiment, a generally disc-shaped plate having a finished outer surface that is exposed when fixture 12 is installed. A rim 56 of plate 14 contacts sheathing 110 when assembly 10 is installed. The opposing outer face 58 of plate 14 is exposed when installed and is provided with a finished, decorative appearance. For example, outer face 58 may comprise a radially sloping surface which is configured to generally merge with a wall or ceiling panel when installed. As seen in FIGS. 9 and 12, cover plate 14 may incorporate a heat sink 59 having internal fins 6o for dissipating heat generated by the lighting fixture. In order to provide sufficient cooling, heat sink 59 may comprise aluminium or other metal alloy. Alternatively, if less heat dissipation is required, heat sink 59 may be modified or eliminated.

It will be seen that the invention is not limited to use with an LED light element but may comprise any suitable light element known to the art which can be adapted for use with the present invention.

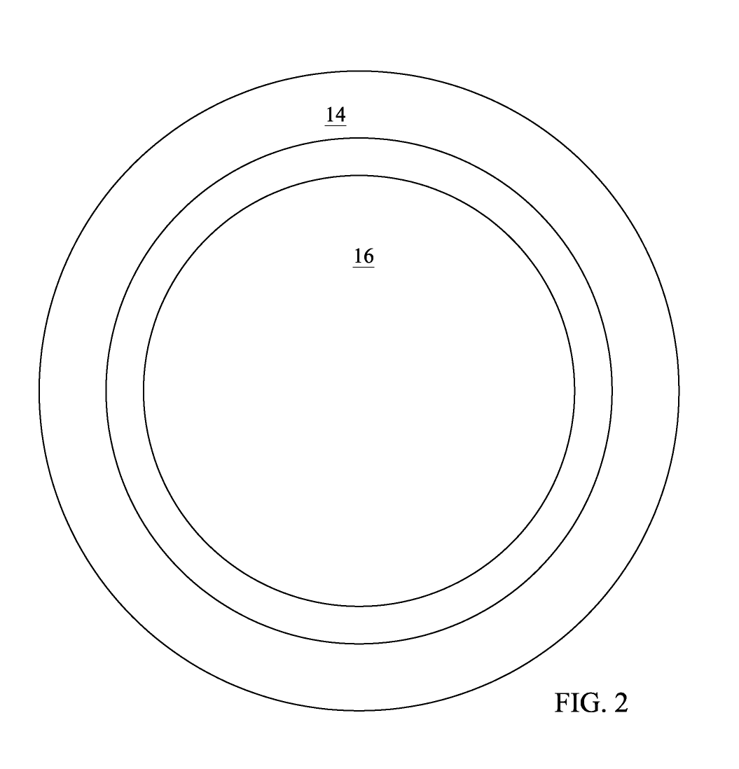

Insert 18 is covered by a decorative translucent or transparent lens 16, as seen in FIGS. 1 and 2. Lens 16 or cover plate 14 may be removed for replacement of LED board 64 if required.

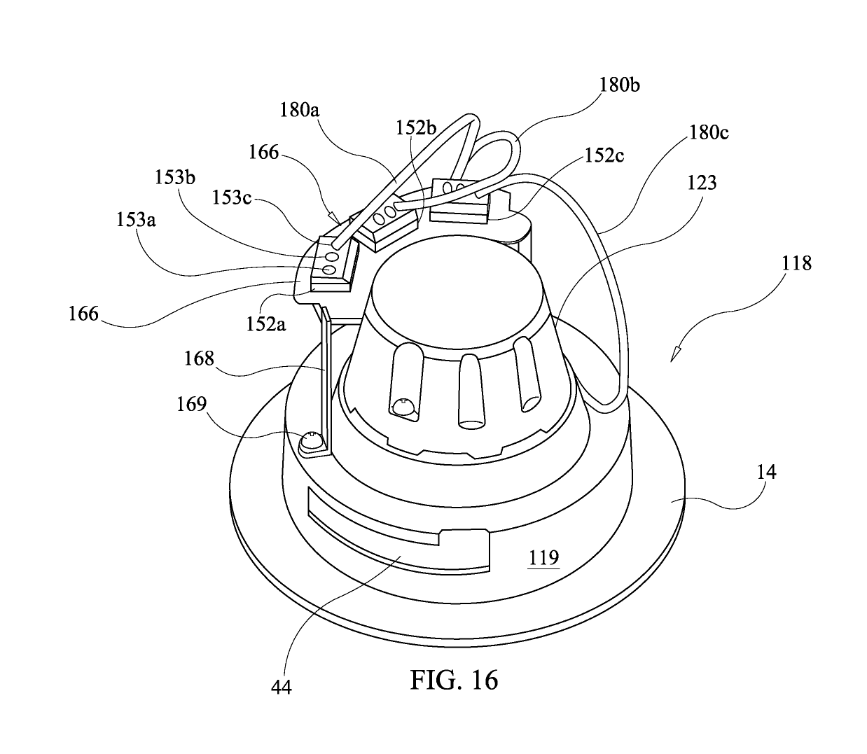

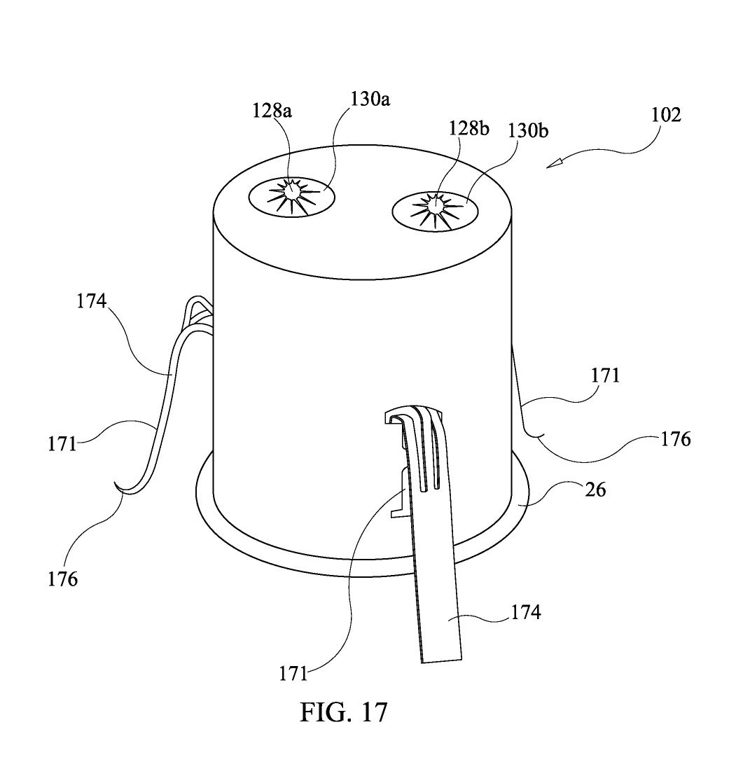

FIGS. 16 and 17 show a second embodiment of a recessed lighting assembly 102 according to the invention. A cylindrical housing or can 102 houses an insert 118, seen in detail in FIG. 16. Can 102 comprises an integral fixture housing and junction box, as with the first embodiment. Can 102 may be provided with multiple openings 128a and 128b to admit household electrical wires, not shown. A household electrical cable may be directly fed into the interior of housing 102 without the need for a separate junction box.

Turning to FIG. 17, flexible inserts 130a and 130b respectively are attached to can 102 within openings 128a and b to retain household electrical cables within the openings and to prevent slippage or movement of the cables. Housing 102 has a flange 126 protruding outwardly from its lower rim to abut a surrounding wall or ceiling surface when installed and to contact an exterior surface of the wallboard or sheathing. Can 102 further comprises an array of spring clips 171, which may comprise 2, 3, 4 or more clips 171, which are configured to secure can 102 to wallboard or other sheathing of a wall, ceiling or other surface. Clips 171 are spot-welded or otherwise fastened to the outside surface of can 102 and project downwardly towards flange 126. Clips 171 each comprise a resilient arm 174 that angles outwardly away from the sidewall of can 102. Arm 174 terminates in a foot 176 that is configured to contact an interior surface of a wallboard or sheathing, facing the interior of the structure. The spring-biasing of clip 171 urges foot 176 towards flange 126 to firmly clamp the sheathing or wallboard between foot 176 and flange 126.

Insert 118, shown in FIG. 16, comprises a cylindrical body 119 and outwardly protruding flange 114. Body 119 includes one or more recessed dogleg grooves 44 similar to the first embodiment. Body 119, in comparison with the first embodiment, is relatively shallow which can reduce fabrication costs. Insert 118 further comprises a dome-shaped enclosure 123 protruding upwardly from body 119. Enclosure 123 may comprise a plastic shell wherein body 119 and enclosure 123 have an open interior for housing electrical components for delivering current to LED light emitters, as described above (not shown). Insert 118 also supports three quick connects 152a, 152b and 152c. These quick connect members are mounted to an arcuate base plate 166 which is parallel to and spaced from flange 114. Plate 166 is located alongside enclosure 123 and allows quick connects 152a-c to be connected to a solid support, thereby permitting enclosure 123 to be fabricated from a thinner and less rigid material. Plate 166 is supported on legs 168 whereby plate 166 is spaced apart from body 119. Legs 168 terminate in feet 169 which are mounted to body 119. Each of quick connects 152a-c are electrically connected to electrical components, not shown, housed within body 119, via leads 180a, 180b and 180c respectively. Quick connects 152a-c are configured to form electrical connections with corresponding ones of household electrical wires, not shown. As with the embodiment of FIGS. 1-15, quick connects 152a-c may comprise Easy Connect members, which may be color coded or otherwise marked for easy identification. Quick connects 152 may comprise sockets 153a-c to receive wire cores of the household wires as well as leads 180a-c.

Can 102 may be installed within a structure by cutting a circular opening in the wallboard or sheathing of a wall, ceiling or other surface. Household wires located within the interior of the wall are fed through one of openings 128a and/or 128b, depending on the location of the wires. In some cases, a ground wire may be fed separately through one of the openings 128, and the current wires are fed through the other of openings 128. The household wires are separated into individual ground, positive and negative wires and the sheathings are stripped to reveal the wire cores. The wire cores are then inserted into respective ones of sockets 153a-c of quick connects 152a-c to form electrical connections with the electrical components of insert 118.

After insert 118 has been electrically connected to the household wire, it may be fastened to can 102, in the same fashion as the embodiment of FIG. 1-15 to complete the installation of the lighting system.

The scope of the invention should not be limited by the preferred embodiments set forth in the examples, but should be given the broadest interpretation consistent with the description as a whole. The claims are not to be limited to the preferred or exemplified embodiments of the invention.

1. A recessed lighting assembly for mounting to a structure, the assembly comprising:
an integrated junction box/housing configured to be mounted to the structure and configured to admit a multi-phase electrical cable into the interior of said junction box/housing;
a removable insert configured to be secured within said junction box/housing, said insert comprising a light emitter or a mount for a light emitter, electrical components for supplying current to said light emitter or mount and an exterior portion which is exposed when said assembly is mounted to said structure; and
a connector for connecting said electrical components to electrical wires of said cable within the interior of said junction box/housing.

2. The assembly of claim 1 wherein said insert further comprises a heat sink configured to absorb and dissipate heat generated by said electric circuit and/or said light emitter.

3. The assembly of claim 2 wherein said heat sink comprises an exterior portion of said insert which is outside said junction box/housing when engaged thereto.

4. The assembly of claim 1 wherein said light emitter comprises one or more light emitting diodes (LEDs).

5. The assembly of claim 1 wherein said connector comprises at least one quick connect member to connect said electrical wires to said insert, said quick connect member comprising a first component for electrical connection to an exposed end of said wire and a second component electrically connected to said electrical components of said insert, wherein the first and second components form an electrical and a mechanical connection therebetween to transmit current from the electrical wires to the electrical components of said insert.

6. The assembly of claim 5 wherein at least the second component of said quick connect member is mounted to said insert.

7. The assembly of claim 5 wherein said at least one quick connect member comprises an integral member, wherein the first component comprises a socket within said quick connect member for receiving and engaging an exposed wire core of a corresponding one of said wires.

8. The assembly of claim 5 wherein said first and second components are separable from each other and said quick connect member comprises a receptacle for receiving a first of said wires and the first and second components comprise engagement members for fastening said components together for forming an electrical and mechanical connection therebetween.

9. The assembly of claim 1 further comprising a support member mounted to said insert wherein said connectors are mounted to said support member.

10. The assembly of claim 1 comprising a plurality of said connectors for engagement individually with said wires.

11. The assembly of claim 1 further comprising at least one fastener for mounting the junction box/housing to the structure.

12. The assembly of claim 11 wherein said fastener is configured to mount said junction box/housing to wallboard or other sheathing member of said structure.

13. The assembly of claim 12 wherein said fastener comprises at least one set of opposing clamp members configured to clamp said sheathing member between said clamp members.

14. The assembly of claim 13 wherein a first of said clamp members comprises a spring clip extending from said junction box/housing biased to move outwardly from said junction box/housing and a second of said clamp members comprises a non-moveable protrusion of said junction box/housing, wherein said spring clip is configured to bear against an inside surface of the sheathing member and the protrusion is configured to bear against an opposed outer surface of the sheathing member.

15. The assembly of claim 1 wherein said insert and said junction box/housing comprise interlocking members to fasten the insert to the junction box/housing.

16. The assembly of claim 15 wherein said interlocking members comprise at least one protrusion extending from said junction box/housing or said insert and a slot within the other of said junction box/housing or insert, wherein the slot is configured to receive said protrusion and is further configured as a cam to tighten said insert into said junction box/housing when said insert is rotated relative to the junction box/housing.

17. The assembly of claim 1 wherein said junction box/housing is configured for installation either during construction of the structure or retrofit into an existing structure.

18. The assembly of claim 1 wherein said junction box/housing comprises a mini-can.

19. A method of installing a light fixture to a structure, wherein the fixture comprises an integrated electrical junction box/housing for a lighting fixture and an insert comprising a light emitter or mount for a light emitter, electrical components for supplying current to the light emitter, a connection for connecting said electrical components to electrical wires within said junction box/housing and an exterior portion which is exposed when said assembly is mounted to said surface, the method comprising the steps of:
feeding a multiphase electrical cable into the interior of the junction box/housing,
mounting said junction box/housing to said structure,
forming an electrical connection between wires of said electrical cable and said insert, and
securing the insert within said junction box/housing.

20. The method of claim 19 wherein said insert comprises at least one quick connect member electrically connected to said electrical components within the insert and said step of forming an electrical connection comprises the further steps of attaching at least one of said wires to said quick connect member.

21. The method of claim 20 wherein said wires are attached to said quick connect member by insertion of an exposed segment of a wire core of said wire into a socket within the quick connect member.

22. The method of claim 19 wherein said insert is secured by twisting the insert to lock together the insert and junction box/housing with a camming action.

23. The method of claim 19 comprising installation of said junction box/housing either during construction of the structure or during a retrofit or renovation of an existing structure.
